(19) United States
(12) Patent Application Publication
(10) Pub. No.: US 2016/0334777 A1
(43) Pub. Date: Nov. 17, 2016

(54) NUMERICAL CONTROLLER CAPABLE OF CHECKING MOUNTING STATE OF TOOL USED FOR MACHINING

(71) Applicant: FANUC Corporation, Minamitsuru-gun (JP)

(72) Inventor: Shuji SATO, Minamitsuru-gun (JP)

(21) Appl. No.: 15/148,330

(22) Filed: May 6, 2016

(30) Foreign Application Priority Data
May 15, 2015 (JP) 2015-099852

(51) Int. Cl. G05B 19/18

(52) U.S. Cl. CPC G05B 19/188; G05B 2219/49375

(57) ABSTRACT

A numerical controller retrieves only a tool change command in an NC program and controls an automatic tool changer to execute tool change based on the retrieved tool change command. The numerical controller controls a camera to capture an image of a tool every time the tool change command is executed, and analyzes the image captured by the camera to calculate a shape and a size of the tool. The calculated tool shape and size are collated with a shape and a size in tool management data stored in the numerical controller, and the result of the collation is displayed on a screen of a display device so that an operator can be informed of it.

### BACKGROUND OF THE INVENTION

1. Field of the Invention

The present invention relates to a numerical controller, and more particularly, to a numerical controller in which only a tool used for actual machining can be inspected based on the shape of a tool actually mounted on a tool magazine or turret.

2. Description of the Related Art

Japanese Patent Application Laid-Open No. 07-001270 discloses an example of a technique for checking whether a tool mounted on a tool magazine or turret is not wrong. According to this known technique, identification information read from a pasted barcode or IC tag or data input by a tool presetter is collated with tool management data prepared in advance.

Further, Japanese Patent Application Laid-Open No. 61-178141 discloses another example of the tool check technique. According to this known technique, a tool management system is provided for a machine tool that comprises a visual sensor, data bank, and NC data creation device. In this tool management system, the visual sensor acquires image data of a plurality of tools attached to an automatic tool changer (ATC) of the machine tool, and the data bank stores the tool number, shape, and size of each tool, as tool data, based on the tool image data acquired by the visual sensor. Furthermore, the NC data creation device compares the tool data stored in the data bank and tool data managed by the NC data creation device itself, thereby identifying the tool.

According to the technique disclosed in Japanese Patent Application Laid-Open No. 61-178141, checking whether mounting of a tool is correct or not is carried out for all of the tools mounted on the automatic tool changer (ATC), without regard to the necessity of the tools for machining, and such a checking operation is naturally time-consuming. Also, there is a problem that a separate NC data creation device must be provided to create a command for causing an NC device to change a tool.

In the technique described above, moreover, a tool mounted on the automatic tool changer is positioned to a position of a camera so that an image of the tool can be captured thereby based on the command output from the NC data creation device. However, this image capture is not performed according to a machining program actually used for machining, and the tools are not identified based on the shape of a tool mounted on a spindle or the like during the machining. Thus, there is a problem that an abnormality that occurs before a tool is taken out from a tool magazine and mounted on the spindle and an abnormality caused as the tool is mounted on a tool holder cannot be identified.

### SUMMARY OF THE INVENTION

Accordingly, the object of the present invention is to provide a numerical controller in which only a tool used for actual machining can be inspected based on the shape of an actually mounted tool.

A numerical controller according to the present invention is configured to control a machine tool according to an NC program to machine a workpiece. The machine tool includes an automatic tool changer and an image pickup unit configured to capture an image of a tool. The numerical controller includes: a tool management data storage unit configured to store tool management data that includes data on at least a shape and a size of the tool associated with a tool number; a tool change command execution unit configured to retrieve only a tool change command in the NC program and control the automatic tool changer to execute tool change based on the retrieved tool change command; a tool image acquisition unit configured to control the image pickup unit to capture the image of the tool mounted on a tool mounting portion of the machine tool every time the tool is changed by the tool change command execution unit, thereby acquiring the tool image; a tool data calculation unit configured to analyze the tool image to calculate the shape and the size of the tool; a collating unit configured to collate the shape and the size of the tool calculated by the tool data calculation unit with a shape and a size associated with the tool number commanded by the tool change command that are stored in the tool management data storage unit; and a display unit configured to display the result of the collation by the collating unit.

The image pickup unit may be secured in a position where the image of the tool around a tool change position of the machine tool is allowed to be captured, and the tool image acquisition unit can control the image pickup unit to capture the tool image.

The image pickup unit may be mounted on a robot, and the tool image acquisition unit can control the robot to move the image pickup unit to a position where the image of the tool around a tool change position of the machine tool is allowed to be captured and control the image pickup unit to capture the tool image.

According to the present invention, only an actually used tool can be reliably inspected based on the shape of an actually mounted tool by performing tool change according to an NC program used in actual machining and inspecting the shape and size of an actually selected tool.

### BRIEF DESCRIPTION OF THE DRAWINGS

The above and other objects and features of the present invention will be obvious from the ensuing description of embodiments with reference to the accompanying drawings, in which:

FIG. 1 is a schematic block diagram showing a numerical controller according to one embodiment of the present invention and a machine tool controlled by the numerical controller;

FIG. 2 is a diagram showing an example of screen display of a machining simulation function of the numerical controller of FIG. 1;

FIG. 3 is a functional block diagram showing the numerical controller according to the one embodiment of the present invention and the machine tool controlled by the numerical controller;

FIG. 4 is a diagram showing an example of calculation processing for tool shape data and tool size data based on a tool image, to be executed by the numerical controller of FIG. 3;

FIG. 5 shows an example of display of the result of collation between a shape and a size of a tool calculated by the numerical controller of FIG. 3 and those in tool management data stored in the numerical controller, on a screen of a display device; and

FIG. 6 is a flowchart showing processing performed on the numerical controller of FIG. 3.

### DETAILED DESCRIPTION OF THE PREFERRED EMBODIMENTS

According to the present invention, a numerical controller for controlling a machine tool, which is provided with a camera secured around a tool change position or a camera configured to be moved around the tool change position by a robot, comprises means for retrieving and executing only a tool change command in an NC program, means for controlling the camera to capture an image of a tool every time the tool change command is executed, and means for analyzing the captured image to calculate a shape and a size of the tool. The calculated tool shape and size are collated with a shape and a size in tool management data stored in the numerical controller, and the result of the collation is displayed on a screen of a display device so that an operator can be informed of it.

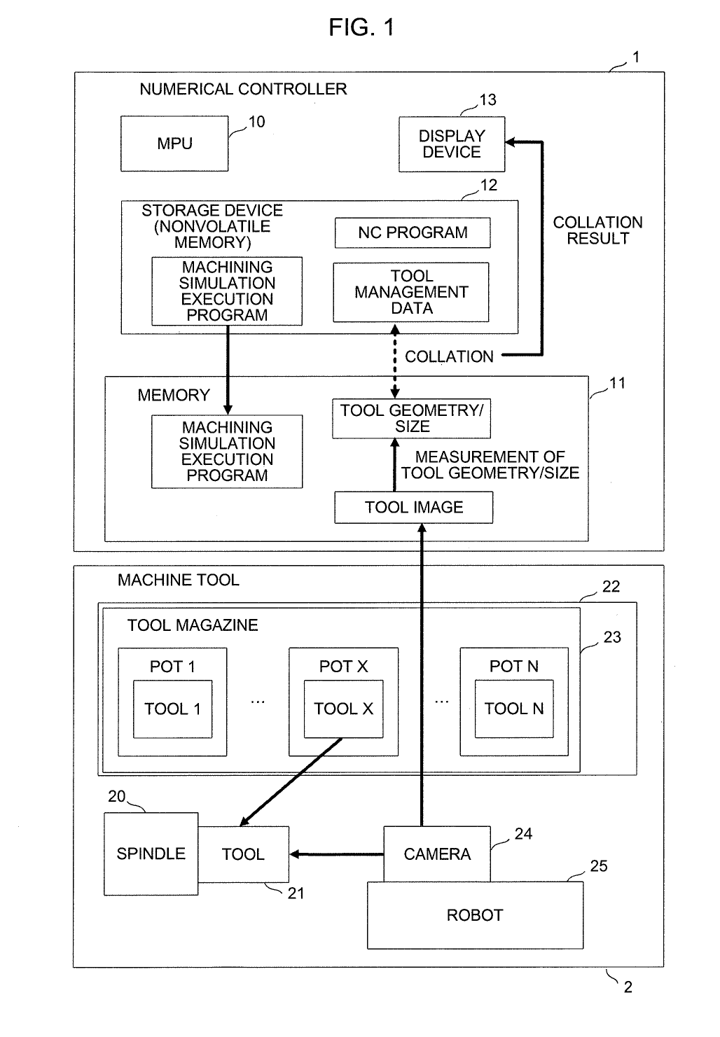

FIG. 1 is a schematic block diagram showing a numerical controller according to one embodiment of the present invention and a machine tool controlled by the numerical controller.

A numerical controller 1 comprises an MPU 10, memory 11, storage device 12, and display device 13, and a machine tool 2 comprises a spindle 20, tool 21, automatic tool changer 22, tool magazine 23, camera 24, and robot 25.

The MPU 10 reads a system program and a machining simulation execution program stored in the storage device 12 onto the memory 11 and executes them. Based on the result of the execution, various parts of the numerical controller are controlled to provide various functions.

In the numerical controller 1 of FIG. 1, part of a machining simulation function (function for graphically simulating the machining status based on the execution of the NC program) provided by executing the machining simulation execution program is incorporated with a function for checking the mounting state of the tool.

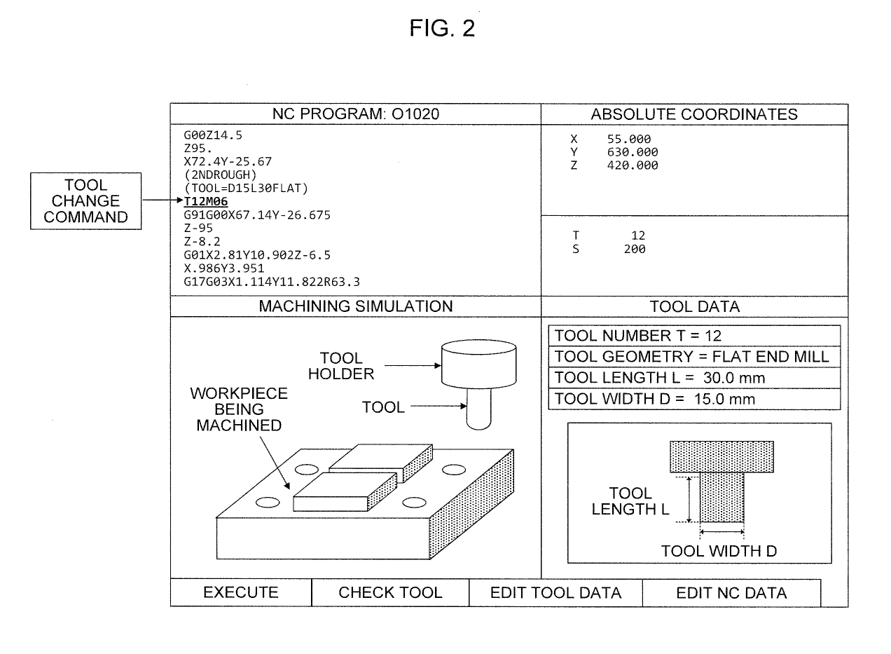

FIG. 2 shows a display example of a screen for the machining simulation function.

As shown in FIG. 2, the NC program (including the tool change command), tool data (including a tool number, tool shape, tool length, and tool diameter), information (machining shape, status information on the machine tool, etc.) on machining simulation, and operation buttons for the machining simulation are displayed on the screen for the machining simulation function. The tool check function of the numerical controller 1 is executed by selecting a “tool check” button shown in FIG. 2.

When the tool check function of the present invention is executed, lines of the NC program stored in the storage device 12 are sequentially read. If the read lines represent a tool change command, the automatic tool changer 22 of the machine tool 2 is controlled so that the specified tool 21 is mounted on the spindle 20, and an image of the tool 21 is captured and acquired by controlling the robot 25, camera 24, and the like.

The tool image acquired by the camera 24 is analyzed to calculate the shape and size of the tool 21, the calculated tool shape and size are collated with shapes and sizes registered in tool management data stored in the storage device 12, and the result of the collation is displayed on the display device 13. These processes are repeatedly performed so that the final line of the NC program is read.

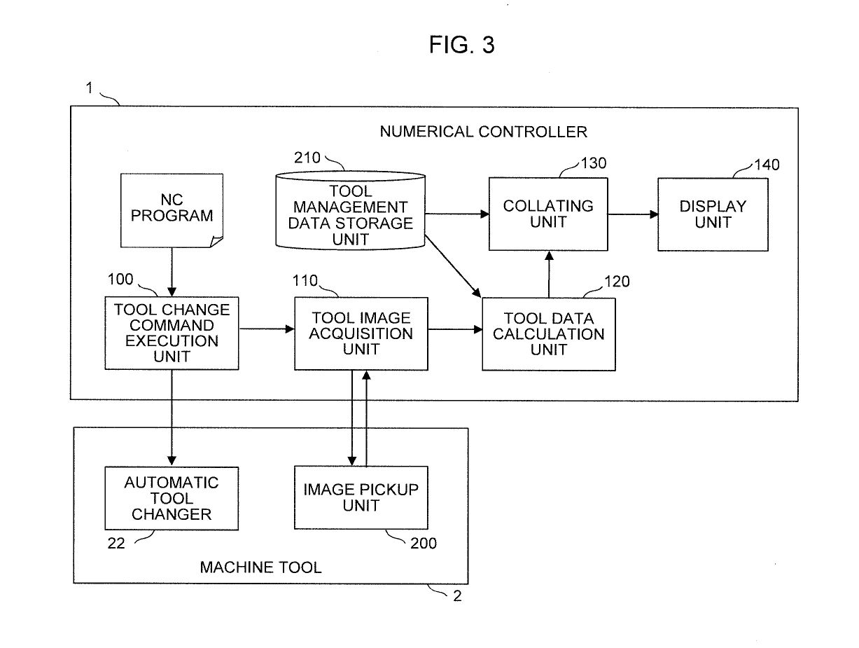

The above-described operation of the numerical controller will be further described in detail with reference to the functional block diagram of FIG. 3 showing the numerical controller 1 and the machine tool 2 of the present embodiment.

The numerical controller 1 comprises tool change command execution means 100, tool image acquisition means 110, tool data calculating means 120, collating means 130, and display means 140. These function means of the numerical controller 1 are means provided as the MPU 10 executes the machining simulation program, system program, and the like.

The machine tool 2 also comprises the automatic tool changer 22 and image pickup means 200.

The tool change command execution means 100 sequentially reads the NC program stored in the storage device 12 and determines whether or not the read command is a tool change command. If the read command is the tool change command, the automatic tool changer 22 is controlled so that the tool mounted on the spindle 20 of the machine tool 2 is replaced with a tool specified by the command. When the tool change by the automatic tool changer 22 is completed, the tool image acquisition means 110 is ordered to acquire the tool image.

On receiving the command from the tool change command execution means 100, the tool image acquisition means 110 controls the image pickup means 200 of the machine tool 2 so as to capture the image of the tool mounted on the spindle 20, acquires the captured tool image, and outputs the acquired image to the tool data calculation means 120. The image pickup means 200 of the machine tool 2 may be composed only of the camera 24 (FIG. 1) secured around the tool change position or configured so that the camera 24 previously mounted on the robot 25 can be moved to the vicinity of the tool change position by controlling the robot 25.

The tool data calculation means 120 calculates tool shape data and tool size data based on the tool image received from the tool image acquisition means 110.

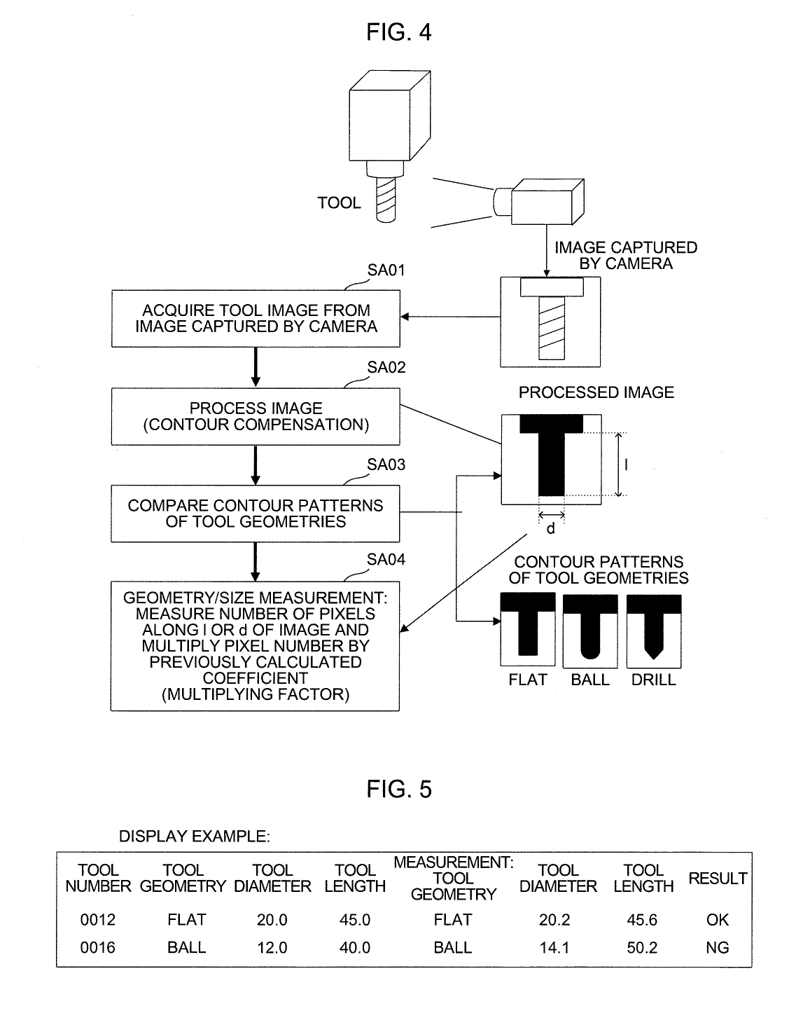

FIG. 4 is a diagram illustrating calculation processing for the tool shape and size data based on the tool image, to be executed by the tool data calculation means 120.

First, the tool image acquisition means 110 acquires a tool image from an image captured by a camera (Step SA01). Then the tool data calculation means 120 creates a contour shape of the tool by applying the acquired the tool image to well-known image processing, such as thresholding based on a color gamut (Step SA02).

Then, the tool data calculation means 120 identifies the type of a tool with a shape similar to the tool contour shape created in Step SA02 by a well-known image matching method or the like, with reference to a tool management data storage unit 210 on the storage device 12. The tool management data storage unit 210 is stored with various data, such as the tool shape, tool size, and tool type, which are associated with tool number (or as tool management data), for each tool as an object of management.

In identifying the type of the tool with the shape similar to the tool contour shape created in Step SA02, the tool contour shape is compared with data on the tool shapes in respective tool management data stored in the tool management data storage unit 210, in terms of pattern, and the type of a tool in the tool management data associated with the tool shape most similar to the created tool contour shape is extracted (Step SA03).

Further, the tool data calculation means 120 calculates the tool shape data and tool size data (tool diameter d, tool length 1, tip angle, etc.) according to the tool type identified in Step SA03, based on the tool contour shape created in Step SA02 (Step SA04). Prior art techniques disclosed in Japanese Patent Applications Laid-Open Nos. 2006-284531, 08-243883 and 04-315556 can be used for this calculation. For example, the number of pixels along the tool diameter or length is counted and the tool diameter or length is calculated by multiplying the pixel number by a previously calculated coefficient (multiplying factor).

Furthermore, the tool data calculation means 120 outputs the calculated tool shape and size data to the collating means 130.

The collating means 130 reads the tool shape (tool type) and size corresponding to the currently selected tool number (or tool number commanded by the tool change command read from the NC program by the tool change command execution means 100) from the tool management data storage unit 210. Then, the collating means 130 collates the read tool shape and size with the tool shape and size data received from the tool data calculation means 120 and outputs the result of the collation to the display means 140. In the collation processing, it is determined that the changed tool is identical to the managed tool if the two tool shapes are identical and if the difference between the tool sizes is not more than a predetermined value (e.g., 5%), for example. If the two tool shapes are not identical or if the difference between the tool sizes is more than the predetermined value, it is determined that the changed tool is not identical to the managed tool.

The display means 140 displays the collation result received from the collating means 130 on the display device 13 so that the operator can ascertain the collation result. FIG. 5 shows a display example of the collation result.

For a tool of a tool number 0012 in the example shown in FIG. 5, tool management data on the tool number 0012 stored in the tool management data storage unit 210 and the tool shape are identical and the difference between the tool sizes is within the range of the predetermined value, with respect to the tool shape and size data calculated from the image of the tool mounted on the spindle 20, so that the collation result is displayed as “OK”. For a tool of a tool number 0016, in contrast, the difference between the tool sizes exceeds the predetermined value, although tool management data on the tool number 0016 stored in the tool management data storage unit 210 and the tool shape are identical, with respect to the tool shape and size data calculated from the image of the tool mounted on the spindle 20, so that the collation result is displayed as “NG”.

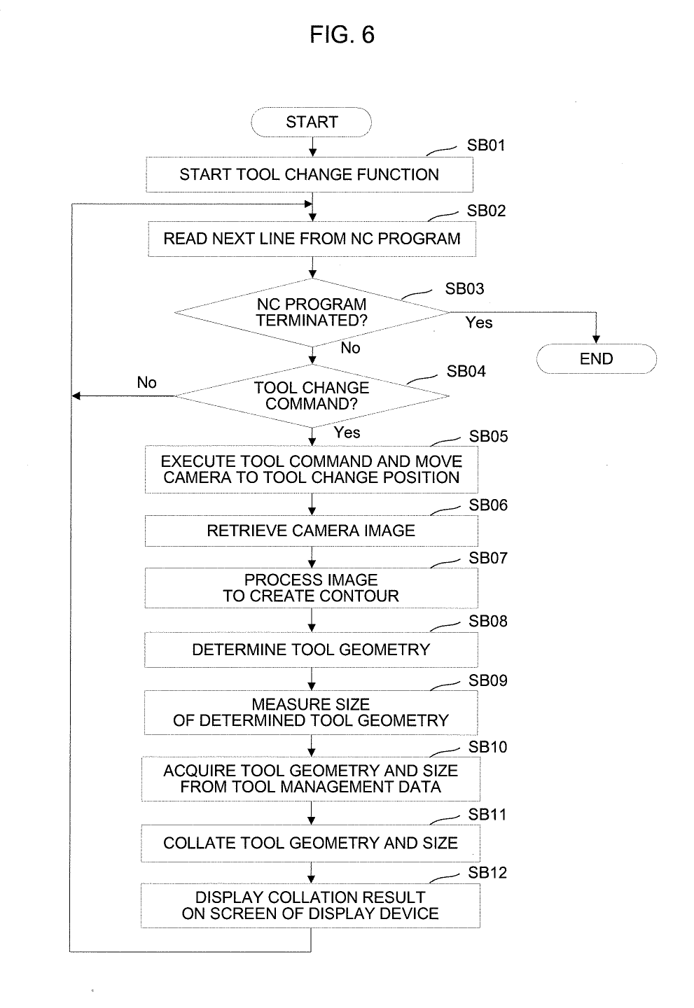

FIG. 6 is a flowchart showing processing performed on the numerical controller 1 of the present embodiment.

[Step SB01] When the machining simulation function is activated, the “machining simulation execution program” in the numerical controller 1 is started, and the screen shown in FIG. 2 is displayed. Then, the “tool check” button on the screen (FIG. 2) is pressed to execute the tool check function of the numerical controller 1.

[Step SB02] One line of an unread data part of the “NC program” is read from the storage device 12 into the memory 11 in the numerical controller 1.

[Step SB03] It is determined whether or not the NC program is terminated. If the NC program is not terminated, the processing proceeds to Step SB04. If the NC program is terminated, this function ends.

[Step SB04] It is determined whether or not the line read in Step SB02 is a tool change command (e.g., T12M06 in the NC program of FIG. 2). If the read line is the tool change command, the processing proceeds to Step SB05. If not, the processing returns to Step SB02.

[Step SB05] The tool change command is executed. If the camera 24 is mounted on the robot 25, a command is also given to the robot 25 to move the camera 24 to the tool change position.

[Step SB06] The image of the tool 21 is retrieved from the camera 24 and loaded into the memory 11.

[Step SB07] The tool image is processed so that its contour shape is created.

[Step SB08] The contour shape of the tool image created in Step SB07 is compared with the tool shape patterns in the tool management data registered in the tool management data storage unit 210, and the nearest shape is retrieved to determine the “tool type”.

[Step SB09] Tool shape data and tool size data (tool diameter, tool length, tip angle, etc.) according to the determined “tool type” are calculated.

[Step SB10] Tool shape data (tool type) and tool size data corresponding to the currently selected tool number, among the tool management data stored in the tool management data storage unit 210, are read into the memory 11 in the numerical controller 1.

[Step SB11] The tool shape and size data calculated from the tool image in Steps SB08 and SB09 are collated with tool shape and size data read from the tool management data storage unit 210 in Step SB10.

[Step SB12] The result of the collation in Step SB11 is displayed on the display device 13, whereupon the processing returns to Step SB02.

Thus, in the numerical controller 1 of the present embodiment, tool change commands described in the machining programs actually used for machining are sequentially executed to acquire the image of the tool 21 mounted on the spindle 20 and the acquired tool image is collated with the tool management data. Consequently, only an expected tool or tools can be checked without wasting time and reliably inspected based on the shape of an actually mounted tool.

While an embodiment of the present invention has been described herein, the invention is not limited to the above-described embodiment and may be suitably modified and embodied in various forms.

1. A numerical controller which controls a machine tool according to an NC program to machine a workpiece, wherein
the machine tool comprises an automatic tool changer and an image pickup unit configured to capture an image of a tool, and
the numerical controller comprises:
a tool management data storage unit configured to store tool management data that includes data on at least a shape and a size of the tool associated with a tool number;
a tool change command execution unit configured to retrieve only a tool change command in the NC program and control the automatic tool changer to execute tool change based on the retrieved tool change command;
a tool image acquisition unit configured to control the image pickup unit to capture the image of the tool mounted on a tool mounting portion of the machine tool every time the tool is changed by the tool change command execution unit, thereby acquiring the tool image;
a tool data calculation unit configured to analyze the tool image to calculate the shape and the size of the tool;
a collating unit configured to collate the shape and the size of the tool calculated by the tool data calculation unit with a shape and a size associated with the tool number commanded by the tool change command that are stored in the tool management data storage unit; and
a display unit configured to display the result of the collation by the collating unit.

2. The numerical controller according to claim 1, wherein the image pickup unit is secured in a position where the image of the tool around a tool change position of the machine tool is allowed to be captured, and the tool image acquisition unit controls the image pickup unit to capture the tool image.

3. The numerical controller according to claim 1, wherein the image pickup unit is mounted on a robot, and the tool image acquisition unit controls the robot to move the image pickup unit to a position where the image of the tool around a tool change position of the machine tool is allowed to be captured and controls the image pickup unit to capture the tool image.
